(19) United States
(12) Patent Application Publication
(10) Pub. No.: US 2026/0016810 A1
(43) Pub. Date: Jan. 15, 2026

(54) CODE GENERATOR CIRCUIT WITH CODE DOPPLER COMPENSATION AND LOCAL REPLICA GENERATOR CIRCUIT USING THE CODE GENERATOR CIRCUIT

(71) Applicant: Airoha Technology Corp., Hsinchu City (TW)

(72) Inventors: Chia-Lung Wu, Tainan City (TW); Ching-Chiao Kuan, Hsinchu County (TW); Yu-Wei Lee, Hsinchu County (TW); Yuan-Wen Ting, Hsinchu City (TW)

(73) Assignee: Airoha Technology Corp., Hsinchu City (TW)

(21) Appl. No.: 18/659,023

(22) Filed: May 9, 2024

(51) Int. Cl. G05B 19/4155

(52) U.S. Cl. CPC G05B 19/4155; G05B 2219/35216

(57) ABSTRACT

A code generator circuit includes a control circuit and a code sequence processing circuit. The control circuit updates an accumulated value by accumulating an increment value per clock cycle, and refers to the accumulated value to generate a control output per clock cycle, wherein the increment value is set based on at least one of a Doppler shift, a block size, and a local replica output sampling rate. The code sequence processing circuit generates a code generator output according to the control output of the control circuit.

### BACKGROUND OF THE INVENTION

### 1. Field of the Invention

The present invention relates to local replica generation, and more particularly, to a code generator circuit with code Doppler compensation and a local replica generator circuit using the code generator circuit.

### 2. Description of the Prior Art

The global navigation satellite system (GNSS) is often described as an “invisible utility”, and is so effective at delivering two essential services-time and position-accurately, reliably and cheaply that many aspects of the modern world have become dependent upon them. Each satellite of the GNSS is equipped with a highly precise atomic clock. When four or more satellites are in view, a GNSS receiver can measure the distance to each satellite by estimating the signal transmission time delay from the satellite to the receiver. From these measurements, a GNSS-embedded device can derive its own position and synchronize to the accurate GNSS system time.

A GNSS satellite signal is modulated by a pseudo random noise (PRN) code. The PRN code is a code sequence with randomly distributed 0's and 1's. Each satellite transmits a unique PRN code. Hence, the GNSS receiver identifies any of the satellites by its unique PRN code. The unique PRN code is continuously repeated. The GNSS receiver can use a local replica version of the unique PRN code to correlate the received satellite signal for acquisition.

Doppler shift of the satellite signal is caused by the relative motion of the GNSS receiver and the GNSS satellite. Hence, the GNSS baseband received signal suffers the Doppler effect, including code Doppler and carrier Doppler, and the GNSS receiver is required to deal with the Doppler effect for acquisition performance improvement.

### SUMMARY OF THE INVENTION

One of the objectives of the claimed invention is to provide a code generator circuit with code Doppler compensation and a local replica generator circuit using the code generator circuit.

According to a first aspect of the present invention, an exemplary code generator circuit is disclosed. The exemplary code generator circuit includes a control circuit and a code sequence processing circuit. The control circuit is arranged to update an accumulated value by accumulating an increment value per clock cycle, and refer to the accumulated value to generate a control output per clock cycle, wherein setting of the increment value depends on at least one of a Doppler shift, a block size, and a local replica output sampling rate. The code sequence processing circuit is arranged to generate a code generator output according to the control output of the control circuit.

According to a second aspect of the present invention, an exemplary local replica generator circuit is disclosed. The exemplary local replica generator circuit includes a code generator circuit, a Doppler-shift generator circuit, and a multiplier circuit. The code generator circuit includes a first control circuit and a code sequence processing circuit. The first control circuit is arranged to update a first accumulated value by accumulating a first increment value per clock cycle, and refer to the first accumulated value to generate a first control output per clock cycle, wherein setting of the first increment value depends on at least one of a Doppler shift, a block size, and a local replica output sampling rate. The code sequence processing circuit is arranged to generate a code generator output according to the first control output of the first control circuit. The Doppler-shift generator circuit includes a second control circuit and a Doppler-shift processing circuit. The second control circuit is arranged to update a second accumulated value by accumulating a second increment value per clock cycle, and refer to the second accumulated value to generate a second control output per clock cycle, wherein setting of the second increment value depends on at least one of the Doppler shift, the block size, and the local replica output sampling rate. The Doppler-shift processing circuit is arranged to generate a Doppler-shift generator output according to the second control output of the second control circuit. The multiplier circuit is arranged to generate a local replica output by performing a multiplication operation upon the code generator output and the Doppler-shift generator output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a local replica generator circuit according to an embodiment of the present invention.

FIG. 2 is a block diagram illustrating the code generator circuit shown in FIG. 1 according to an embodiment of the present invention.

FIG. 3 is a block diagram illustrating implementation of the code generator circuit shown in FIG. 2 according to an embodiment of the present invention.

FIG. 4 is a block diagram illustrating implementation of an NCO circuit and an index generator used by the code generator circuit according to an embodiment of the present invention.

FIG. 5 is block diagram illustrating another implementation of the code generator circuit shown in FIG. 1 according to an embodiment of the present invention.

FIG. 6 is a block diagram illustrating the Doppler-shift generator circuit shown in FIG. 1 according to an embodiment of the present invention.

FIG. 7 is a block diagram illustrating implementation of an NCO circuit and an index generator used by the Doppler-shift generator circuit according to an embodiment of the present invention.

FIG. 8 is block diagram illustrating another implementation of the Doppler-shift generator circuit shown in FIG. 1 according to an embodiment of the present invention.

FIG. 9 is a diagram illustrating the multiplier circuit shown in FIG. 1 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

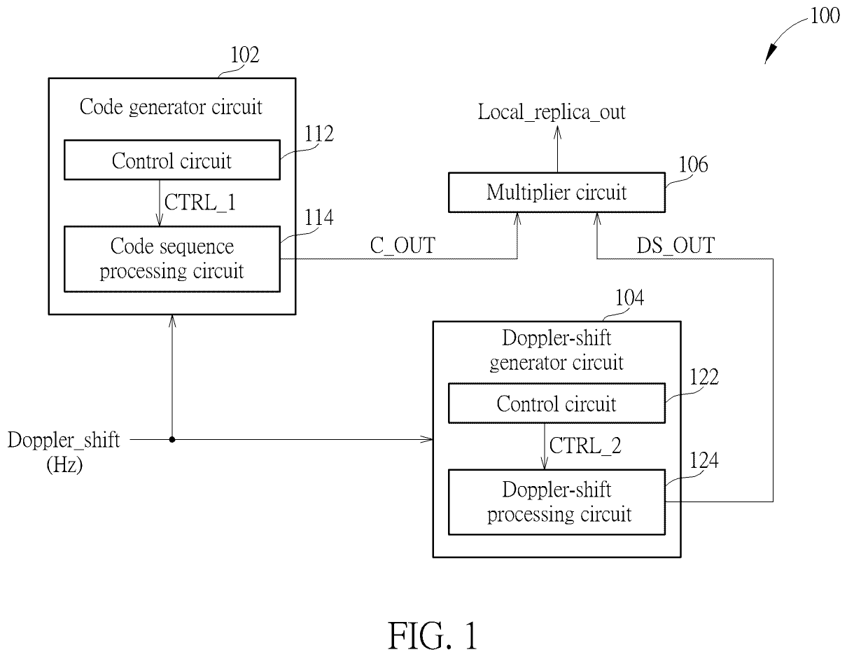

FIG. 1 is a block diagram illustrating a local replica generator circuit according to an embodiment of the present invention. By way of example, but not limitation, the local replica generator circuit 100 may be a GNSS local replica generator used for generating and outputting a local replica Local replica out (e.g., a PRN code sequence) to a GNSS correlator, where the GNSS correlator further receives a GNSS baseband received signal, and performs correlation computation according to the local replica Local replica out and the GNSS baseband received signal. However, this is for illustrative purposes only, and is not meant to be a limitation of the present invention. In practice, any application using the proposed local replica generator design and/or the proposed code generator design falls within the scope of the present invention.

In some embodiments of the present invention, the GNSS correlator may perform the correlation computation in the frequency domain. Hence, the sampling rate of the local replica Local replica out is required to be the same as the up-sampling rate of the GNSS baseband received signal. For example, the PRN code used by Galileo E5 has 10230 code bits (also called chips due to bearing no useful data information) per millisecond (ms). If the frequency-domain correlation is implemented using 32768-point fast Fourier transform (FFT), the GNSS baseband received signal should be up-sampled to have 32768 samples/ms, and the sampling rate of the local replica Local_replica_out should also be 32768 samples/ms that is higher than the chip rate 10230 chips/ms of the PRN code specified by Galileo E5. However, applying a typical up-sampling method (e.g., zero-padding or interpolation) to the local replica may need extra hardware or more complicated computation.

In some embodiments of the present invention, the frequency-domain correlation performed by the GNSS correlator may employ block-wise processing. For example, the 32768-point FFT may be decomposed into eight 4096-point FFTs, and the GNSS correlator may be equipped with eight FFT engines for block-wise processing. The local replica Local_replica_out is required to provide one block of eight samples (i.e., block size=8 samples/block) per clock cycle, where the eight samples are provided to eight FFT engines, respectively. However, using a typical method to buffer the local replica and re-arrange the stored local replica to provide blocks of samples needed by the block-wise processing may need extra hardware and more controls.

As mentioned above, the GNSS baseband received signal suffers the Doppler effect, including code Doppler and carrier Doppler, and the GNSS receiver is required to deal with the Doppler effect for acquisition performance improvement. If the GNSS receiver deals with code Doppler and carrier Doppler separately, a complicated circuit structure is needed. If code Doppler compensation is applied in the time-domain, more software control efforts are needed. If the code Doppler compensation is applied in the frequency-domain, the compensation accuracy is constrained by the FFT size.

To address above issues, the present invention proposes a local replica generator design which is capable of performing code Doppler compensation (whose compensation accuracy is not constrained by the FFT size) and carrier Doppler compensation at the same time, up-sampling the local replica to any sampling rate, and/or outputting all samples of one block per clock cycle for follow-up block-wise correlation processing. More specifically, the proposed local replica generator design employs a code generator design which is capable of performing code Doppler compensation (whose compensation accuracy is not constrained by the FFT size), up-sampling the local replica to any sampling rate, and/or outputting all samples of one block per clock cycle. Further details of the proposed local replica generator design and proposed code generator design are described as below with reference to the accompanying drawings.

As shown in FIG. 1, the local replica generator circuit 100 includes a code generator circuit 102, a Doppler-shift generator circuit 104, and a multiplier circuit 106. The code generator circuit 102 includes a control circuit 112 and a code sequence processing circuit 114. The control circuit 112 is arranged to generate a control output CTRL_1, where the control output CTRL_1 includes control information used by the code sequence processing circuit 114. The code sequence processing circuit 114 is arranged to generate a code generator output C_OUT according to the control output CTRL_1 of the control circuit 112. The Doppler shift Dopple shift (Hz) is provided to the code generator circuit 102. With the control output CTRL_1 properly set based on the Doppler shift Dopple shift, the code generator output C_OUT provided to the multiplier circuit 106 is code Doppler compensated.

The Doppler-shift generator circuit 104 includes a control circuit 122 and a Doppler-shift processing circuit 124. The control circuit 122 is arranged to generate a control output CTRL_2, where the control output CTRL_2 includes control information used by the Doppler-shift processing circuit 124. The Doppler-shift processing circuit 124 is arranged to generate a Doppler-shift generator output DS_OUT according to the control output CTRL_2 of the control circuit 122. The Doppler shift Dopple shift (Hz) is also provided to the Doppler-shift generator circuit 104. With the control output CTRL_2 properly set based on the Doppler shift Dopple shift (Hz), the Doppler-shift generator output DS_OUT provided to the multiplier circuit 106 is for carrier Doppler compensation.

The multiplier circuit 106 is arranged to generate the local replica output Local_replica_out by performing a multiplication operation upon the code generator output C_OUT and the Doppler-shift generator output DS_OUT. As mentioned above, the code generator output C_OUT generated in response to the Doppler shift Dopple shift (Hz) is code Doppler compensated, and the Doppler-shift generator output DS_OUT generated in response to the same Doppler shift Dopple shift (Hz) is for carrier Doppler compensation. Hence, code Doppler compensation and carrier Doppler compensation can be jointly achieved by the local replica output Local_replica_out. Compared to a conventional GNSS receiver design that needs a complicated circuit structure to deal with code Doppler and carrier Doppler separately, a GNSS receiver using the proposed local replica generator circuit 100 to deal with code Doppler and carrier Doppler jointly has lower hardware complexity.

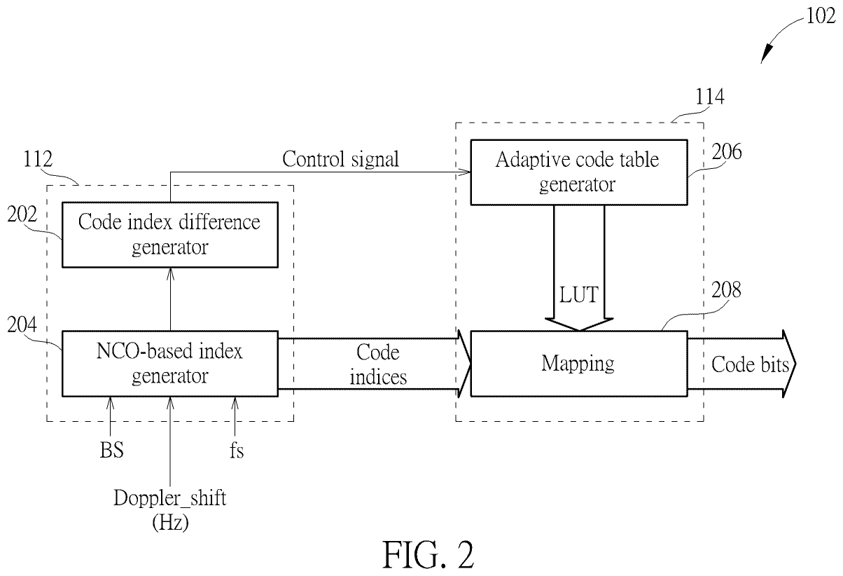

In addition to code Doppler compensation, the code generator circuit 102 is capable of up-sampling the local replica to any sampling rate and/or outputting all samples of one block per clock cycle for block-wise correlation processing in the frequency domain. FIG. 2 is a block diagram illustrating the code generator circuit 102 shown in FIG. 1 according to an embodiment of the present invention. The control circuit 112 of the code generator circuit 102 may include a code index difference generator circuit (labeled by “Code index difference generator”) 202 and a numerically controlled oscillator (NCO) based index generator circuit (labeled by “NCO-based index generator”) 204. The code sequence processing circuit 114 may include an adaptive code table generator circuit (labeled by “Adaptive code table generator”) 206 and a mapping circuit (labeled by “Mapping”) 208. In a case where the frequency-domain correlation performed by the GNSS correlator employs block-wise processing, the code generator output C_OUT of the code generator circuit 102 includes a plurality of code bits (samples) of one block that are output per clock cycle. The control output CTRL_1 shown in FIG. 1 may include a plurality of code indices and a control signal, where the control signal is supplied to the adaptive code table generator circuit 206, and the code indices are supplied to the mapping circuit 208. The NCO-based index generator circuit 204 is arranged to generate the code indices, and the mapping circuit 208 is arranged to output multiple code bits (samples) of one block according to a lookup table (LUT) and the code indices. The code index difference generator circuit 202 is arranged to generate a code index difference as the control signal of the adaptive code table generator circuit 206. The code index difference generated per clock cycle is used to instruct the adaptive code table generator circuit 206 to adaptively update the LUT used by the mapping circuit 208.

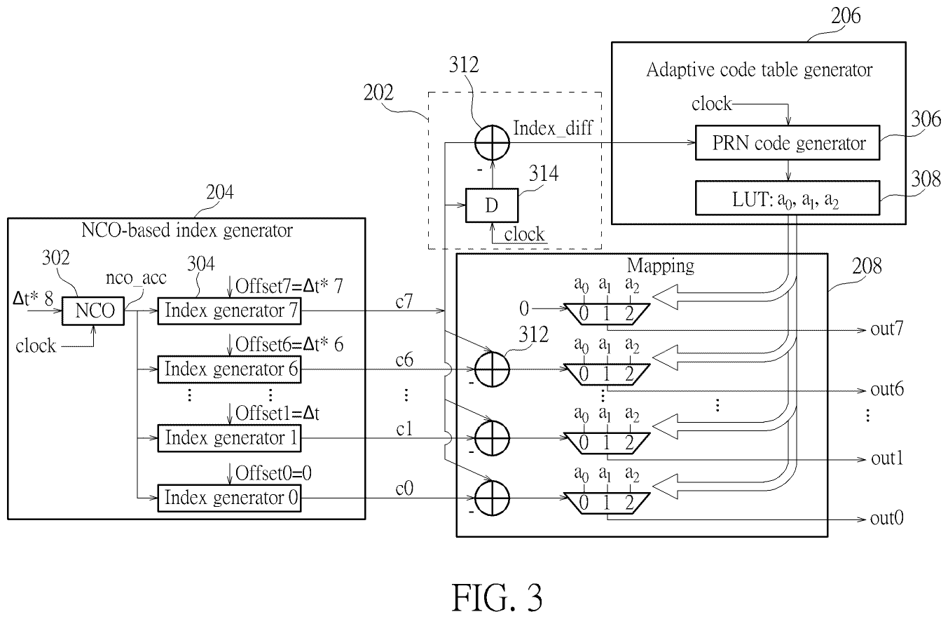

Regarding generation of code indices (particularly, “code Doppler compensated” code indices), the NCO-based index generator circuit 204 may consider some or all of a plurality of factors, including a Doppler shift Doppler shift (Hz), a block size BS (samples/block), and a local replica output sampling rate fₛ (samples/s), where the local replica output sampling rate fₛ (samples/s) may be different from (e.g., higher than) a local replica chip rate f_{c} (chips/s) such as 10.23M chips/s (i.e., 10230 chips/ms) specified by Galileo E5/BeiDou B2/GPS L5. FIG. 3 is a block diagram illustrating implementation of the code generator circuit 102 shown in FIG. 2 according to an embodiment of the present invention. The NCO-based index generator circuit (labeled by “NCO-based index generator”) 204 may include an NCO circuit (labeled by “NCO”) 302 and a plurality of index generators (labeled by “Index generator 7”, “Index generator 6”, . . . , “Index generator 1”, “Index generator 0”) 304. The code index difference generator 202 may include a subtractor 312 and a buffer (labeled by “D”) 314. For example, the buffer 314 may be implemented using D-type flip-flops or other storage elements. The adaptive code table generator circuit (labeled by “Adaptive code table generator”) 206 may include a PRN code generator circuit (labeled by “PRN code generator”) 306 and an LUT 308. The mapping circuit (labeled by “Mapping”) 208 may include a plurality of subtractors 312 and a plurality of multiplexers 310.

For better comprehension of technical features of the present invention, the following assumes that the block size is 8 (i.e., BS=8). Hence, the NCO-based index generator circuit 204 shown in FIG. 3 has 8 index generators 304 for outputting 8 code indices c7, c6, . . . , c1, c0, respectively; and the mapping circuit 208 has 8 multiplexers 310 for outputting 8 code bits out7, out6, . . . , out1, out0, respectively. However, this is for illustrative purposes only, and is not meant to be a limitation of the present invention. In practice, the proposed code generator design is capable of supporting any block size and/or generating any number of samples per clock cycle to meet requirements of block-wise correlation processing in the frequency domain.

The NCO circuit 302 of the NCO-based index generator circuit 204 is arranged to update an accumulated value nco_acc by accumulating an increment value Δt*BS (e.g., BS=8 in this embodiment) per clock cycle. The computation of the accumulated value nco_acc can be expressed using the following formula.

$$nco\_acc = nco\_acc + ( Δ t * BS ) \qquad ( 1 )$$

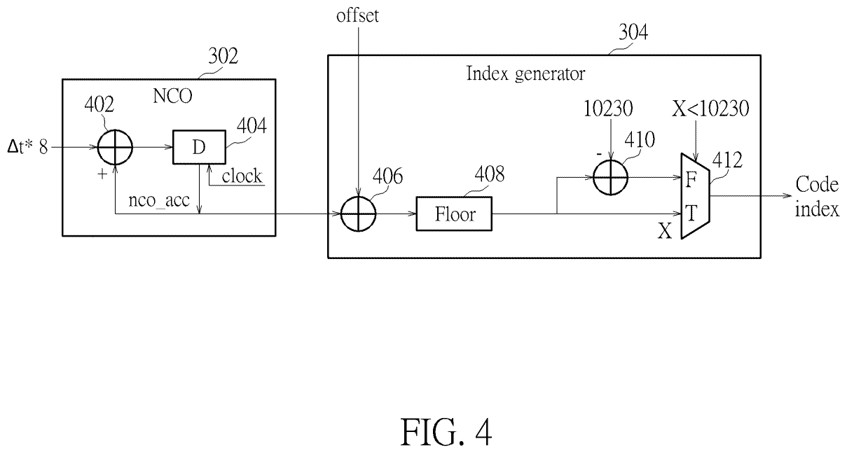

For example, the NCO circuit 302 may include an adder 402 and a buffer (labeled by “D”) 404 as shown in FIG. 4. For example, the buffer 404 may be implemented using D-type flip-flops or other storage elements. In accordance with the proposed code generator design, setting of the increment value Δt*BS (e.g., BS=8 in this embodiment) accumulated per clock cycle depends on the Doppler shift f_{d} (Hz), the block size BS (samples/block), the local replica output sampling rate fₛ (samples/s), or any combination thereof. The value of Δt may be calculated using the following formulas.

$$Δ t = \frac{Code\_length}{N} + codeDopp \qquad ( 2 )$$

$$codeDopp = {f}_{d} * \frac{1 {0}^{- 3} seconds}{N} * \frac{{f}_{c}}{{f}_{L}} \qquad ( 3 )$$

In above formulas (2) and (3), f_{c} is the local replica chip rate (chips/s), Code_length is a code length per millisecond under the local replica chip rate f_{c}, N is a code length per millisecond under the local replica output sampling rate fₛ (samples/s), codeDopp is code Doppler compensation, f_{d} is the Doppler shift (Hz), and f_{L} is a carrier frequency. For example, N=32768 for frequency-domain correlation using 32768-point FFT, Code_length=10230 for Galileo E5, and the frequency ratio f_{c}/f_{L}=1/116.5 for Galileo E5.

Since the block size BS is 8 in this embodiment, the NCO circuit 302 has to accumulate Δt*8 per clock cycle. For example, when the Doppler shift (Hz) is a zero value, the increment value Δt*8 is equal to 2.49755859375 under N=32768, Code_length=10230, and f_{c}/f_{L}=1/116.5. There are 8 offset values Offset0=0, Offset1=Δt, . . . , Offset6=Δt*6, Offset7=Δt*7 that are smaller than the increment value Δt*8 and evenly distributed, and are used by the index generator circuits (labeled by “Index generator 0”, “Index generator 1”, . . . , “Index generator 6”, “Index generator 7”) 304 to generate 8 index values c0, c1, . . . , c6, c7, respectively. Each of the index generator circuits 304 is arranged to receive the same accumulated value nco_acc, and generate a code index by applying an arithmetic operation to a sum of an offset value and the accumulated value nco_acc. For example, each of the index generator circuits 304 can be implemented by an adder 406, a floor function operator 408, a subtractor 410, and a multiplexer 412 shown in FIG. 4. The computation of a code index code_Index can be expressed using the following formula.

$$code\_Index = floor ( nco\_acc + offset ) \% Code\_length \qquad ( 4 )$$

In above formula (4), nco_acc is the accumulated value, offset is the offset value, Code_length is a code length per millisecond under the local replica chip rate f_{c} (chips/s), floor(⋅) is a floor function, and % is a modulo operation. For example, Code_length=10230 for Galileo E5.

As shown in FIG. 3, the code index difference generator 202 includes a subtractor 312 and a buffer (labeled by “D”) 314. For example, the buffer 314 may be implemented using D-type flip-flops or other storage elements. Hence, the code index difference generator 202 is arranged to buffer a specific code index (e.g., c7) that is generated during a previous clock cycle, and subtract the specific code index (e.g., c7) generated during the previous clock cycle from the specific code index (e.g., c7) generated during a current clock cycle to generate the code index difference Index_diff. The code index difference Index_diff acts as a control signal of the adaptive code table generator circuit 206 (particularly, PRN code generator circuit 306 of adaptive code table generator circuit 206). Specifically, the PRN code generator circuit 306 adaptively updates the LUT 308 according to the code index difference Index_diff that is generated per clock cycle. For example, the PRN code generator circuit 306 may be implemented using linear-feedback shift registers (LFSRs). The PRN code generator circuit 306 generates and outputs k chips (code bits) {a₀, . . . , aₖ} under control of the code index difference Index_diff, where P≤k≤T, T is the LUT size, and T and P depend on the GNSS system specification. Regarding the embodiment shown in FIG. 3, T=3 and P=2. Since the increment value Δt*8 is equal to 2.49755859375, it means the PRN code generator circuit 306 is expected to generate and output 2.49755859375 chips per clock cycle. Since 2.49755859375 is not an integer, the code index difference Index_diff is selected from {2, 3} in different clock cycles to make the PRN code generator circuit 306 generate 2 (k=2) chips and 3 (k=3) chips in an interleaving fashion. In this way, an average number of chips generated from the PRN code generator circuit 306 per clock cycle can be equal to 2.49755859375. When Index_diff=2, the RN code generator circuit 306 generates next 2 chips (code bits) to update the LUT 308, where a₀ and a₁ of the current LUT are updated by the 2 chips (code bits) newly generated from the RN code generator circuit 306, and as of the current LUT is set by a₀ of the previous LUT. When Index_diff=3, the RN code generator circuit 306 generates next 3 chips (code bits) to update the LUT 308, where a₀, a₁, a₂ of the current LUT are set by the 3 chips (code bits) newly generated from the RN code generator circuit 306.

The mapping circuit 208 shown in FIG. 3 is arranged to output code bits out0, out1, . . . , out6, out7 of one block per clock cycle according to the LUT 308 and the code indices c0, c1, . . . , c6, c7. In this embodiment, the mapping circuit 208 searches the LUT 308 (which includes 3 code bits {a₀, a₁, a₂}) for a code bit outi according to a difference (c7−ci) between a corresponding code index ci and a specific code index c7 (which is an output of an index generator circuit that receives the largest offset value Δt*7). As shown in FIG. 3, one of the multiplexers 310 outputs a₀ as the code bit out7 in response to 0 (i.e., c7−c7=0), one of the multiplexers 310 outputs one of {a₀, a₁, a₂} as the code bit out6 in response to (c7−c6), one of the multiplexers 310 outputs one of {a₀, a₁, a₂} as the code bit out1 in response to (c7−c1), and one of the multiplexers 310 outputs one of {a₀, a₁, a₂} as the code bit out0 in response to (c7−c0).

The proposed code generator design shown in FIG. 3 is used for generating multiple samples of one block per clock cycle to meet the requirements of follow-up block-wise correlation processing in the frequency domain. However, this is for illustrative purposes only, and is not meant to be a limitation of the present invention. The same design concept can also be applied under a condition that the frequency-domain correlation does not employ block-wise processing (i.e., the block size is equal to 1).

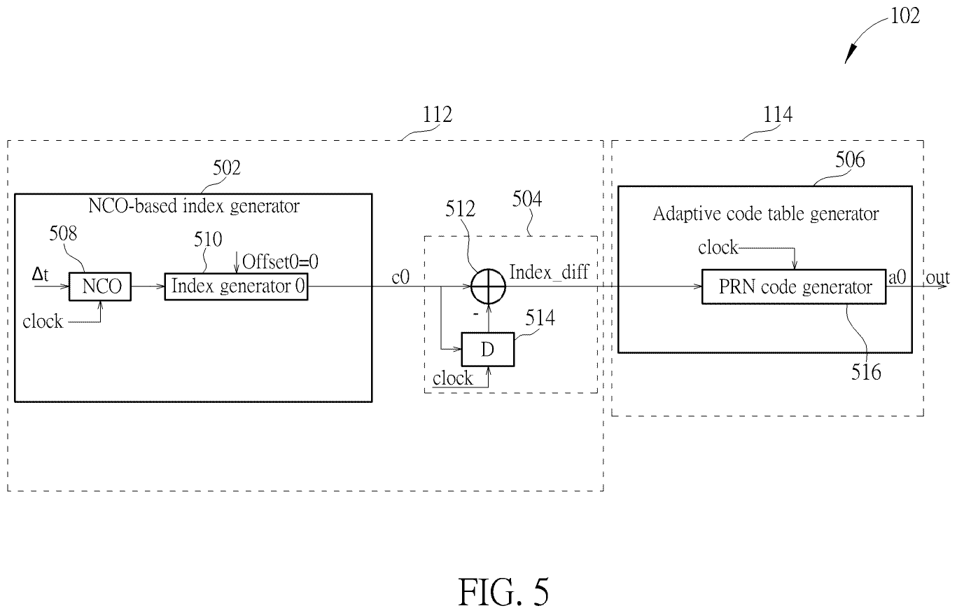

FIG. 5 is block diagram illustrating another implementation of the code generator circuit 102 shown in FIG. 1 according to an embodiment of the present invention. In this embodiment, the control circuit 112 includes an NCO-based index generator circuit (labeled by “NCO-based index generator”) 502 and a code index difference generator circuit 504, and the code sequence processing circuit 114 includes an adaptive code table generator circuit (labeled by “Adaptive code table generator”) 506. The circuit design of the code generator circuit 102 shown in FIG. 5 is a simplified version of the circuit design of the code generator circuit 102 shown in FIG. 3. Since the block size is equal to 1 (i.e., BS=1), the code generator output C_OUT includes only a single code bit “out” that is output per clock cycle. The NCO-based index generator 502 needs only one index generator circuit (labeled by “Index generator 0”) 510. Since the block size is equal to 1 (i.e., BS=1), the increment value accumulated by the NCO circuit 508 is set by Δt. An operation of the index generator circuit 510 is the same as that of the index generator circuit (labeled by “Index generator 0”) 304 shown in FIG. 3. For example, the index generator circuit 510 may be implemented by the adder 406, the floor function operator 408, the subtractor 410, and the multiplexer 412 shown in FIG. 4.

The code index difference generator circuit 504 includes a subtractor 512 and a buffer (labeled by “D”) 514. For example, the buffer 514 may be implemented using D-type flip-flops or other storage elements. Hence, the code index difference generator 502 is arranged to buffer the single code index c0 that is generated during a previous clock cycle, and subtract the single code index c0 generated during the previous clock cycle from the single code index c0 generated during a current clock cycle to generate the code index difference Index_diff. Like the code index difference generator circuit 202 shown in FIG. 3, the code index difference generator circuit 504 outputs the code index difference Index_diff as a control signal of the adaptive code table generator circuit 506 (particularly, PRN code generator circuit 516 of adaptive code table generator circuit 506). Since an output of the PRN code generator circuit 516 directly acts as an output of the code generator circuit 102, the mapping circuit 208 shown in FIG. 3 is omitted from the PRN code generator circuit 506. In this embodiment, the code index difference Index_diff is selected from {0, 1} in different clock cycles. When Index_diff=1, the RN code generator circuit 516 generates the next 1 chip (code bit) to act a code bit output of the code generator circuit 102. When Index_diff=0, the RN code generator circuit 516 repeatedly generates the current 1 chip (code bit) to act a code bit output of the code generator circuit 102. Considering a case where Δt=0.5, the output of the index generator circuit 510 would be co=0, 0, 1, 1, 2, 2, 3, 3, . . . , the output of the code index difference generator circuit 504 would be Index_diff=1, 0, 1, 0, 1, 0, 1, 0, . . . , and the output of the PRN code generator circuit 516 would be out=chip0, chip0, chip1, chip1, chip2, chip2, . . . .

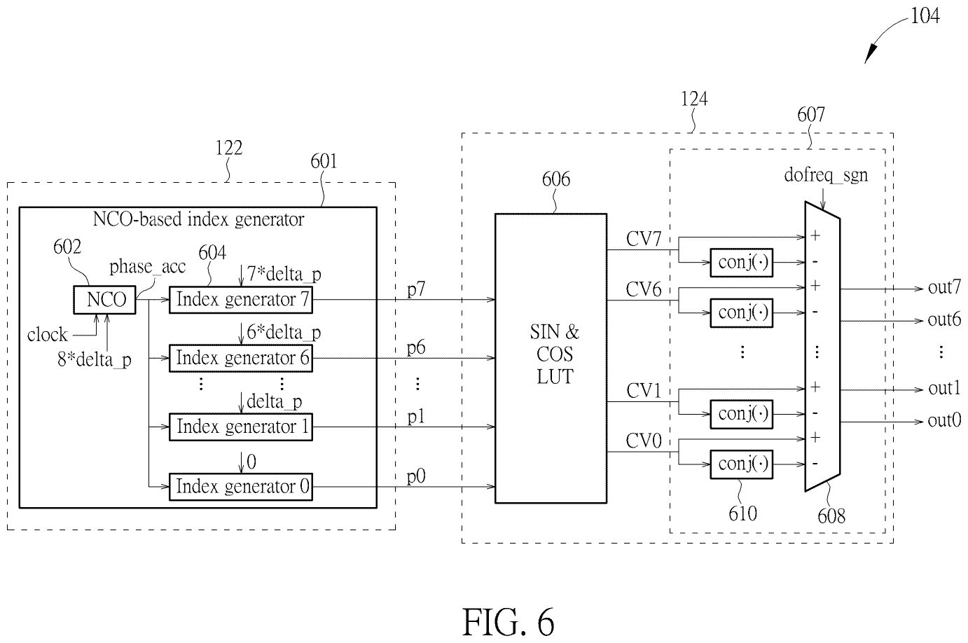

FIG. 6 is a block diagram illustrating the Doppler-shift generator circuit 104 shown in FIG. 1 according to an embodiment of the present invention. The control circuit 122 of the Doppler-shift generator circuit 104 may include an NCO-based index generator circuit (labeled by “NCO-based index generator”) 601. The Doppler-shift processing circuit 124 may include a lookup table (labeled by “SIN & COS LUT) 606 and a post-processing circuit 607. In a case where the frequency-domain correlation performed by the GNSS correlator employs block-wise processing, the Doppler-shift generator output DS_OUT of the Doppler-shift generator circuit 104 includes a plurality of complex outputs output per clock cycle. The control output CTRL_2 shown in FIG. 1 may include a plurality of phase indices that are supplied to the lookup table 606. The NCO-based index generator circuit 601 is arranged to generate the phase indices. The lookup table 606 is arranged to output a plurality of complex values according to the phase indices, respectively. The post-processing circuit 607 is arranged to generate the complex outputs according to the complex values and polarity of the Doppler shift. A complex output generated from the Doppler-shift generator circuit 104 may be expressed by cos(2π*f_{d}*n)+j*sin(2π*f_{d}*n), where f_{d} is the Doppler-shift (Hz).

Regarding generation of phase indices, the NCO-based index generator circuit 601 may consider some or all of a plurality of factors, including the Doppler shift f_{d} (Hz), the block size BS (samples/block), and the local replica output sampling rate fₛ (samples/s), where the local replica output sampling rate fₛ (samples/s) may be different from (e.g., higher than) a local replica chip rate f_{c} (chips/s) such as 10.23M chips/s (i.e., 10230 chips/ms) specified by Galileo E5/BeiDou B2/GPS L5. As shown in FIG. 6, the NCO-based index generator circuit 601 includes an NCO circuit (labeled by “NCO”) 602 and a plurality of index generators (labeled by “Index generator 7”, “Index generator 6”, . . . , “Index generator 1”, “Index generator 0”) 604. For better comprehension of technical features of the present invention, the following assumes that the block size is 8 (i.e., BS=8 samples/block). Hence, the NCO-based index generator circuit 601 has 8 index generators 604 for outputting 8 phase indices p7, p6, . . . , p1, p0, respectively; and the post-processing circuit 607 outputs 8 complex outputs out7, out6, . . . , out1, out0 per clock cycle. However, this is for illustrative purposes only, and is not meant to be a limitation of the present invention.

The NCO circuit 602 of the NCO-based index generator circuit 601 is arranged to update an accumulated value phase acc by accumulating an increment value delta_p*BS (e.g., BS=8 in this embodiment) per clock cycle. The computation of the accumulated value phase_acc can be expressed using the following formula.

$$phase\_acc = phase\_acc + ( delta\_p * BS ) \qquad ( 5 )$$

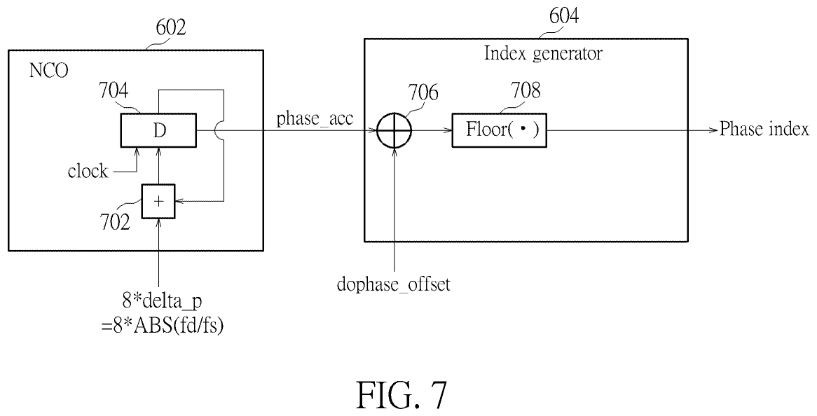

For example, the NCO circuit 302 may include an adder 702 and a D-type flip flop (labeled by “D”) 704 as shown in FIG. 7. In accordance with the proposed Doppler-shift generator design, setting of the increment value delta_p*BS (e.g., BS=8 in this embodiment) accumulated per clock cycle depends on the Doppler shift f_{d} (Hz), the block size BS (samples/block), the local replica output sampling rate fₛ (samples/s), or any combination thereof. The value of delta_p may be calculated using the following formula.

$$delta\_p = ABS ( \frac{{f}_{d}}{{f}_{s}} ) \qquad ( 6 )$$

In above formula (6), ABS(⋅) is an absolute value function, f_{d} is the Doppler shift, and fₛ is the local replica output sampling rate.

Since the block size BS is 8 in this embodiment, the NCO circuit 602 has to accumulate delta_p*8 per clock cycle. There are 8 offset values dophase_offset=0, dophase_offset=Δt, . . . , dophase_offset=Δt*6, dophase_offset=Δt*7 that are smaller than the increment value phase_p*8 and evenly distributed, and are used by the index generator circuits (labeled by “Index generator 0”, “Index generator 1”, . . . , “Index generator 6”, “Index generator 7”) 604 to generate 8 phase values p0, p1, . . . , p6, p7, respectively. Each of the index generator circuits 604 is arranged to receive the same accumulated value phase acc, and generate a phase index by applying an arithmetic operation to a sum of an offset value dophase_offset and the accumulated value phase acc. For example, each of the index generator circuits 604 can be implemented by an adder 706 and a floor function operator 708 shown in FIG. 7. The computation of a phase index phase_Index can be expressed using the following formula.

$$phase\_Index = floor ( phase\_acc + dophase\_offset ) \qquad ( 7 )$$

In above formula (5), floor(⋅) is a floor function.

The lookup table 606 records a plurality of pre-calculated sine values and a plurality of pre-calculated cosine values indexed by different phase indices, and outputs the complex values CV7, CV6, . . . , CV1, CV0 according to the phase indices p7, p6, . . . , p1, p0, respectively. The post-processing circuit 607 includes conjugate operators (labeled by “conj(⋅)”) 610 and multiplexer 608, wherein the multiplexer 608 is controlled by polarity of the Doppler shift (i.e., dofreq_sgn=sgn(f_{d}), where sgn(⋅) is a sign function). When dofreq_{sgn}=sgn(f_{d})=+1, the multiplexer 608 selects the complex values CV7, CV6, . . . , CV1, CV0 as the complex outputs out7, out6, . . . , out1, out0, respectively. When dofreq_{sgn}=sgn(f_{d})=−1, the multiplexer 608 selects conjugates of complex values CV7, CV6, . . . , CV1, CV0 as the complex outputs out7, out6, . . . , out1, out0, respectively.

The proposed Doppler-shift generator design shown in FIG. 6 is used for generating multiple samples per clock cycle to meet the requirements of follow-up block-wise correlation processing in the frequency domain. However, this is for illustrative purposes only, and is not meant to be a limitation of the present invention. The same design concept can also be applied under a condition that the frequency-domain correlation does not employ block-wise processing (i.e., the block size is equal to 1).

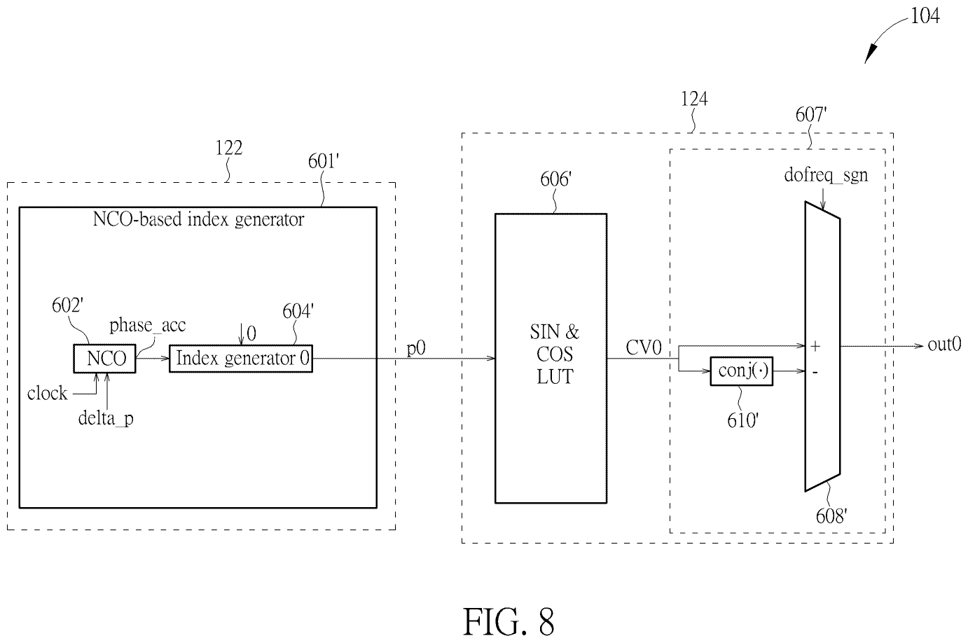

FIG. 8 is block diagram illustrating another implementation of the Doppler-shift generator circuit 104 shown in FIG. 1 according to an embodiment of the present invention. In this embodiment, the control circuit 122 includes an NCO-based index generator circuit (labeled by “NCO-based index generator”) 601′, and the Doppler-shift processing circuit 124 includes a lookup table (labeled by “SIN & COS LUT”) 606′ and a post-processing circuit 607′. The circuit design of the Doppler-shift generator circuit 104 shown in FIG. 8 is a simplified version of the circuit design of the Doppler-shift generator circuit 104 shown in FIG. 6. Since the block size is equal to 1 (i.e., BS=1), the Doppler-shift generator design shown in FIG. 8 uses an increment value set by delta_p, generates only a single phase index p0 per clock cycle, generates only a single complex value CV0 per clock cycle, and generates only a single complex output out0 per clock cycle. For example, the NCO circuit 602′ accumulates an increment value delta_p per clock cycle, the index generator (labeled by “Index generator 0”) 604′ generate the phase index p0 according to the accumulated value phase acc, the lookup table 606′ receives only a single phase index p0 per clock cycle, and the post-processing circuit 607′ (which includes one conjugate operator 610′ and one multiplexer 608′) refers to the complex value CV0 and the polarity of the Doppler shift to output only a single complex output out0 per clock cycle.

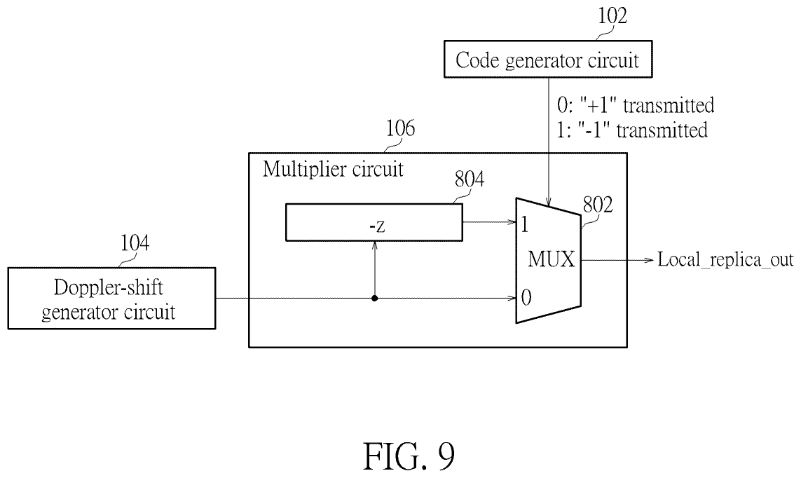

The multiplier circuit 106 shown in FIG. 1 is arranged to generate the local replica output Local_replica_out by performing a multiplication operation upon the code generator output C_OUT and the Doppler-shift generator output DS_OUT. In some embodiments of the present invention, the multiplication operation can be simply implemented using a multiplexer. FIG. 9 is a diagram illustrating the multiplier circuit 106 shown in FIG. 1 according to an embodiment of the present invention. The satellite data is transmitted by using a binary phase shift keying (BPSK) modulation scheme. Hence, a logic value 0 of the PRN code sequence is transformed to +1 for BPSK modulation, and a logic value 1 of the PRN code sequence is transformed to −1 for BPSK modulation. Regarding a GNSS receiver using the local replica generator circuit 100, a logic value “0” of the code generator output C_OUT is transformed to “+1” for correlation computation, and a logic value “1” of the code generator output C_OUT is transformed to “−1” for correlation computation. A complex output generated from the Doppler-shift generator circuit 104 is expressed by cos(2π*f_{d}*n)+j*sin(2π*f_{d}*n). The logic values {0, 1} of the code generator output C_OUT are transformed to {+1, −1} for correlation computation. The multiplication of the code generator output C_OUT and the Doppler-shift generator output DS_OUT can be implemented using a multiplexer. As shown in FIG. 9, the multiplier circuit 106 includes a negative operator (labeled by “−z”) 804 and a multiplexer (MUX) 802. The negative operator 804 is arranged to generate a negative version-cos(2π*f_{d}*n)−j*sin(2π*f_{d}*n) of a complex output cos(2π*f_{d}*n)+j*sin(2π*f_{d}*n) of the Doppler-shift generator output DS_OUT. When a code bit of the code generator output C_OUT has a logic value “0”, the MUX 820 selects the complex output COS (2π*f_{d}*n)+j*sin(2π*f_{d}*n) as a sample (which is a complex value) of the local replica Local_replica_out used by follow-up frequency-domain correlation. When a code bit of the code generator output C_OUT has a logic value “1”, the MUX 820 selects the negative version −cos(2π*f_{d}*n)−j*sin(2π*f_{d}*n) as a sample (which is a complex value) of the local replica Local_replica_out used by follow-up frequency-domain correlation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A code generator circuit comprising:
a control circuit, arranged to update an accumulated value by accumulating an increment value per clock cycle, and refer to the accumulated value to generate a control output per clock cycle, wherein setting of the increment value depends on at least one of a Doppler shift, a block size, and a local replica output sampling rate; and
a code sequence processing circuit, arranged to generate a code generator output according to the control output of the control circuit.

2. The code generator circuit of claim 1, wherein the increment value is set by BS*Δt, where BS is the block size, and Δt is computed as below:
$$Δ t = \frac{Code\_length}{N} + codeDopp and codeDopp = {f}_{d} * \frac{1 {0}^{- 3} seconds}{N} * \frac{{f}_{c}}{{f}_{L}} ,$$
where f_{c} is the local replica chip rate, Code_length is a code length per millisecond under the local replica chip rate, N is a code length per millisecond under the local replica output sampling rate, codeDopp is code Doppler compensation, f_{d} is the Doppler shift, and f_{L} is a carrier frequency.

3. The code generator circuit of claim 1, wherein the code generator output comprises a plurality of code bits that are output per clock cycle.

4. The code generator circuit of claim 3, wherein the control output comprises a plurality of code indices; the control circuit comprises:
a numerically controlled oscillator (NCO) based index generator circuit, arranged to generate the plurality of code indices; and
the code sequence processing circuit comprises:
a mapping circuit, arranged to output the plurality of code bits according to a lookup table and the plurality of code indices.

5. The code generator circuit of claim 4, wherein the NCO based index generator circuit comprises:
an NCO circuit, arranged to generate the accumulated value according to the increment value; and
a plurality of index generator circuits, each arranged to receive the accumulated value, and generate a code index by applying an arithmetic operation to a sum of an offset value and the accumulated value, wherein a plurality of different offset values used by the plurality of index generator circuits are smaller than the increment value.

6. The code generator circuit of claim 4, wherein the code index is computed as below:
code_Index=floor(nco_acc+offset)%Code_length, where code_Index is the code index, nco_acc is the accumulated value, offset is the offset value, Code_length is a code length per millisecond under a local replica chip rate, floor(⋅) is a floor function, and % is a modulo operation.

7. The code generator circuit of claim 4, wherein the mapping circuit is arranged to search the lookup table for one of the plurality of code bits according to a difference between a specific code index included in the plurality of code indices and one of the plurality of code indices.

8. The code generator circuit of claim 4, wherein the control output further comprises a code index difference; the control circuit further comprises:
a code index difference generator circuit, arranged to buffer a specific code index that is generated during a previous clock cycle, and subtract the specific code index generated during the previous clock cycle from the specific code index generated during a current clock cycle to generate the code index difference; and
the code sequence processing circuit further comprises:
a pseudo random noise (PRN) code generator circuit, arranged to adaptively update the lookup table in response to the code index difference.

9. The code generator circuit of claim 1, wherein the code generator output comprises only a single code bit that is output per clock cycle.

10. The code generator circuit of claim 9, wherein the control output comprises a code index difference and only a single code index;
the control circuit comprises:
a numerically controlled oscillator (NCO) based index generator circuit, arranged to generate the single code index; and
a code index difference generator circuit, arranged to buffer the single code index that is generated during a previous clock cycle, and subtract the single code index generated during the previous clock cycle from the single code index generated during a current clock cycle to generate the code index difference; and
the code sequence processing circuit comprises:
a pseudo random noise (PRN) code generator circuit, arranged to output the single bit in response to the code index difference.

11. The code generator circuit of claim 10, wherein the NCO based index generator circuit comprises:
an NCO circuit, arranged to generate the accumulated value according to the increment value; and
an index generator circuit, arranged to receive the accumulated value, and generate the single code index by applying an arithmetic operation to the single code index according to the accumulated value.

12. The code generator circuit of claim 11, wherein the code index is computed as below:
code_Index=floor(nco_acc+offset)%Code_length, where code_Index is the code index, nco_acc is the accumulated value, offset is the single offset value, Code_length is a code length per millisecond under a local replica chip rate, floor(⋅) is a floor function, and % is a modulo operation.

13. A local replica generator circuit comprising:
a code generator circuit, comprising:
a first control circuit, arranged to update a first accumulated value by accumulating a first increment value per clock cycle, and refer to the first accumulated value to generate a first control output per clock cycle, wherein setting of the first increment value depends on at least one of a Doppler shift, a block size, and a local replica output sampling rate; and
a code sequence processing circuit, arranged to generate a code generator output according to the first control output of the first control circuit;
a Doppler-shift generator circuit, comprising:
a second control circuit, arranged to update a second accumulated value by accumulating a second increment value per clock cycle, and refer to the second accumulated value to generate a second control output per clock cycle, wherein setting of the second increment value depends on at least one of the Doppler shift, the block size, and the local replica output sampling rate; and
a Doppler-shift processing circuit, arranged to generate a Doppler-shift generator output according to the second control output of the second control circuit; and
a multiplier circuit, arranged to generate a local replica output of the local replica generator circuit by performing a multiplication operation upon the code generator output and the Doppler-shift generator output.

14. The local replica generator circuit of claim 13, wherein the second increment value is set by BS*delta_p, where BS is the block size, and delta_p is computed as below:
$$delta\_p = ABS ( \frac{{f}_{d}}{{f}_{s}} ) ,$$
where ABS(⋅) is an absolute value function, f_{d} is the Doppler shift, and fₛ is the local replica output sampling rate.

15. The local replica generator circuit of claim 13, wherein the Doppler-shift generator output comprises a plurality of complex outputs that are output per clock cycle.

16. The local replica generator circuit of claim 15, wherein the second control output comprises a plurality of phase indices; the second control circuit comprises:
a numerically controlled oscillator (NCO) based index generator circuit, arranged to generate the plurality of phase indices; and
the Doppler-shift processing circuit comprises:
a lookup table, arranged to output a plurality of complex values according to the plurality of phase indices, respectively; and
a post-processing circuit, arranged to generate the plurality of complex outputs according to polarity of the Doppler shift and the plurality of complex values.

17. The local replica generator circuit of claim 16, wherein the NCO based index generator circuit comprises:
an NCO circuit, arranged to generate the second accumulated value according to the second increment value; and
a plurality of index generator circuits, each arranged to receive the second accumulated value, and generate a phase index by applying an arithmetic operation to a sum of an offset value and the accumulated value, wherein a plurality of different offset values used by the plurality of index generator circuits are smaller than the second increment value.

18. The local replica generator circuit of claim 17, wherein the phase index is computed as below:
phase_Index=floor(phase_acc+dophase_offset), where phase_Index is the phase index, phase_acc is the second accumulated value, dophase_offset is the offset value, and floor(⋅) is a floor function.

19. The local replica generator circuit of claim 13, wherein the Doppler-shift generator output comprises only a single complex output that is output per clock cycle.

20. The local replica generator circuit of claim 19, wherein the second control output comprises only a single phase index; the second control circuit comprises:
a numerically controlled oscillator (NCO) based index generator circuit, arranged to generate the single phase index; and
the Doppler-shift processing circuit comprises:
a lookup table, arranged to output a single complex value according to the single phase index; and
a post-processing circuit, arranged to generate the single complex output according to polarity of the Doppler shift and the single complex value.
